(19) United States
(12) Patent Application Publication
(10) Pub. No.: US 2026/0109011 A1
(43) Pub. Date: Apr. 23, 2026

(54) Power tool having a direction switch for selecting a direction of rotation

(71) Applicant: Hilti Aktiengesellschaft, Schaan (LI)

(72) Inventors: Joshua FLECK, München (DE); Rory BRITZ, Starnberg (DE)

(21) Appl. No.: 19/352,994

(22) Filed: Oct. 8, 2025

(30) Foreign Application Priority Data
Oct. 23, 2024 (EP) 24208305.3

(51) Int. Cl. B25D 16/00

(52) U.S. Cl. CPC B25D 16/006; B25D 2216/0015; B25D 2216/0023; B25D 2216/0084; B25D 2250/121; B25D 2250/265

(57) ABSTRACT

A power tool having a bidirectional rotary drive (4), including a machine housing (1) having a handle section (2) integrally formed thereon and a main switch (3) arranged within reach of the handle section for switching the rotary drive (4) on and off, and a direction switch (5) for selecting the direction of rotation of the rotary drive (4), which is designed as a slide switch that can be operated on both sides of the machine housing (1) depending on the direction of rotation to be selected, wherein a latching contour (7) containing at least two switching positions is integrally formed on a central edge region (6) of the direction switch (5) and interacts with a spring that is arranged on the machine housing (1) and engage with the contour without any play.

This claims priority to European Patent Application EP24208305.3, filed October 23, 2024 which is hereby incorporated by reference herein.

The present invention relates to a power tool having a bidirectional rotary drive.

The field of application of the invention extends to hand-held power tools, in particular drills, drill drivers, hammer drills, electric screwdrivers and the like. In such power tools, the user can usually select the direction of rotation of the rotary drive between a clockwise rotation and a counterclockwise rotation by means of a manual changeover switch located on the outside of the machine housing. Such a direction switch can be designed as a rotary switch or a slide switch that is of interest within the scope of the present invention.

### BACKGROUND

Direction switches for power tools having a bidirectional rotary drive, which switches are designed as slide switches, are accessible from both sides of the machine housing and are usually arranged in a corresponding opening in the region of the handle section of the machine housing, can be found in the generally known prior art. The direction switch can thus be pressed either in a first direction to select a first direction of rotation or in the opposite second direction to select the opposite direction of rotation. When the direction switch is fully pressed in, its operating surface is usually flush with the surface of the machine housing, which corresponds to the desired switching position. Such a direction switch can be connected to a linear or pivotable gear mechanism inside the housing in order to convert the manually mechanically set switching position into the switching position of an electric switch.

### SUMMARY OF THE INVENTION

In practice, such direction switches can be subjected to being excessively pressed, meaning that the direction switch is pushed deeper into the machine housing than would be necessary to reach the electrical switching position. This can damage the electric switch and/or the gearing means. In addition, the desired switching position often cannot be reliably set because the operation of the switch in conjunction with the gearing means is subject to play. In particular, in direction switches which, in addition to setting the two directions of rotation in a middle switching position, are also supposed to allow a neutral switching position to be selected, this cannot be guaranteed in an operationally safe manner under these circumstances.

It is an object of the present invention to improve a power tool of the type in question in such a way that a correct switching position of the direction switch can be set in an operationally safe manner using simple technical means.

The present invention provides power tool having a bidirectional rotary drive (4), comprising a machine housing (1) having a handle section (2) formed thereon and a main switch (3) arranged within reach of the handle section for switching the rotary drive (4) on and off, and a direction switch (5) for selecting the direction of rotation of the rotary drive (4), which is designed as a slide switch that can be operated on both sides of the machine housing (1) depending on the direction of rotation to be selected.

The invention includes the technical teaching that a latching contour containing at least two switching positions is integrally formed on a central region of a direction switch designed as a slide switch, which latching contour interacts with spring means that are arranged on the machine housing and engage in said contour without any play.

The at least two switching positions correspond to switching between a clockwise rotation and a counterclockwise rotation of the rotary drive, also referred to as left-hand rotation and right-hand rotation. A third switching position can be provided for a middle neutral position in which the rotary drive is stationary, for example for a chisel function of a hammer drill. It may be provided that the middle position corresponds to a position for securing the tool during transportation, in which the main switch cannot be operated and the power tool cannot therefore be switched on.

The spring means according to the invention exert a permanent resilient pressure on the latching contour so that the distance between adjacent switching positions and the operating force can be easily adjusted by their shape. The central edge region of a direction switch of the type in question, which is located inside the machine housing in the section between the operating surfaces on either side, is preferably used for such a locked switching function. Since a direction switch according to the invention is preferably flat, the latching contour can be optimally arranged in its edge region; the edge region facing the tool is preferably used for this.

According to a preferred embodiment of the invention, the spring means arranged on the machine housing side consist of a spring tongue integrally formed in the handle section of the machine housing, which extends outward and has a preferably rounded cam section at the distal end, which resiliently comes to rest on the latching contour of the direction switch. For play-free interaction, the latching contour can have the same rounded shape as the cam section of the spring tongue that engages therein, which also contributes to a precise switching feel. Preferably, the latching contour is wave-shaped, with its wave trough regions each forming a switching position. However, it is also conceivable for the latching contour to be triangular to enable an engagement without any play. By the spring tongue being preferably integrally formed directly on the machine housing, the spring means can be simply manufactured by injection molding. However, it is additionally also conceivable for separate components made of spring steel or elastomer elements to be used as the spring means.

Preferably, the spring means acting on the latching contour are pretensioned. In the case of a spring tongue, this can be achieved in a simple, functionally integrated manner by means of a guide rib that acts on the opposite end of the direction switch and is formed on the machine housing. In addition, it is conceivable for further guide ribs to be integrally formed which surround the direction switch so as to be parallel to and spaced apart from one another, each of which ensures the longitudinal guidance of the direction switch within the continuous housing receptacle in order to ensure jam-free operation even with high dust levels.

According to a further measure that improves the invention, the direction switch has an arrow marking or the like on the top for visualizing the selected switching position, which marking is visible through a window opening in the handle section of the machine housing. To ensure ergonomic handling the window opening is preferably located on the top of the machine housing near the handle section.

Preferably, the arrow marking of the direction switch comprises a forward-pointing arrow for indicating a clockwise direction of rotation and a rearward-pointing arrow arranged in parallel therewith and spaced apart therefrom for indicating a counterclockwise direction of rotation. The forward-pointing arrow points toward the tool, whereas the rearward-pointing arrow points toward the operator. Due to the window opening being masked, the engaged switching position can be clearly read. The size of the window opening depends on the geometry of the latching contour, namely its wavelength.

With regard to indicating the switching position in this way, it is also possible to make the region between the two arrows in the window opening visible in order to indicate a middle neutral position of the direction switch. In this case, the arrows may either no longer be visible or at least only partially visible in the window opening in the edge region. This gives the operator a clear indication that a neutral position has been selected. However, it is additionally also conceivable to mark the neutral position with a separate symbol, for example an “N”, which is located in the region between the two arrows. However, the variant with the arrows only being partially visible in the window opening has the advantage of short switching strokes. This very compact variant is made possible because the direction switch according to the invention can be operated with virtually no play, which is the prerequisite for a correspondingly precise display.

According to a further measure that improves the invention, it is proposed that the direction switch has an edge shoulder on each side adjacently to the latching contour, which interacts with a stop structure projecting centrally from the machine housing in order to form end stops on both sides. The two edge shoulders preferably form a recess on the edge of the flat direction switch, from which, however, the centrally arranged latching contour projects. In the case of a direction switch made of plastic such a contour can also be easily realized by injection molding. The edge shoulder on both sides prevents excessive pressing of the direction switch and thus also damage to the electric switch that follows in the causal chain. In the case of power tools with an integrated bearing block of an integrated vibration compensation, the stop structure projecting from the machine housing can also be used to lock such a bearing block by providing corresponding undercuts or the like.

According to a preferred embodiment of the invention, it is proposed that the direction switch designed as a slide switch is arranged on the outside of the handle section in such a way that, when the handle section is grasped, it can be operated in one direction by using at least the thumb of one hand. In connection with this, the main switch arranged adjacently to the direction switch can be designed as a two-finger switch and arranged on the inside of the handle section in such a way that it can be operated by using at least the index and/or middle finger of one hand when the handle section is grasped.

### BRIEF DESCRIPTION OF THE DRAWINGS

Further measures improving the invention are explained in more detail below together with the description of a preferred exemplary embodiment of the invention with reference to the figures. In the drawings:

FIG. 1 is a schematic side view of a power tool having a direction switch arranged on the handle section for selecting the direction of rotation of the rotary drive,

FIG. 2 is a partial longitudinal section through the machine housing in the region of the handle section,

FIG. 3 is a detailed view in the region of the latching contour of the direction switch,

FIG. 4 is a graphic representation of the switching positions of the direction switch created by the latching contour,

FIGS. 5a to 5c are a sequence of plan views of the optical display of the various switching positions, and

FIG. 6 is a side view of the machine housing in the region of a direction switch used therein.

### DETAILED DESCRIPTION

According to FIG. 1, a power tool designed here as a hammer drill consists of a machine housing 1 having a handle section 2 formed thereon, within reach of which a main switch 3 is provided for switching on and off a rotary drive 4 integrated into the machine housing 1. A direction switch 5 arranged adjacently thereto in the region of the handle section 2 serves to select the direction of rotation of the rotary drive 4. The direction switch 5 is designed as a slide switch that can be operated on both sides of the machine housing 1, depending on the direction of rotation to be selected.

The direction switch 5, designed as a slide switch, is arranged on the outside of the handle section 2 of the machine housing 1 in such a way that when the handle section 2 is grasped, it can be operated in one direction at least with the thumb of one hand. In contrast, the main switch 3 arranged adjacently thereto is designed in the manner of a two-finger switch and is arranged on the inside of the handle section 2 in such a way that it can be operated preferably using the index and middle fingers of one hand when the handle section 2 is grasped.

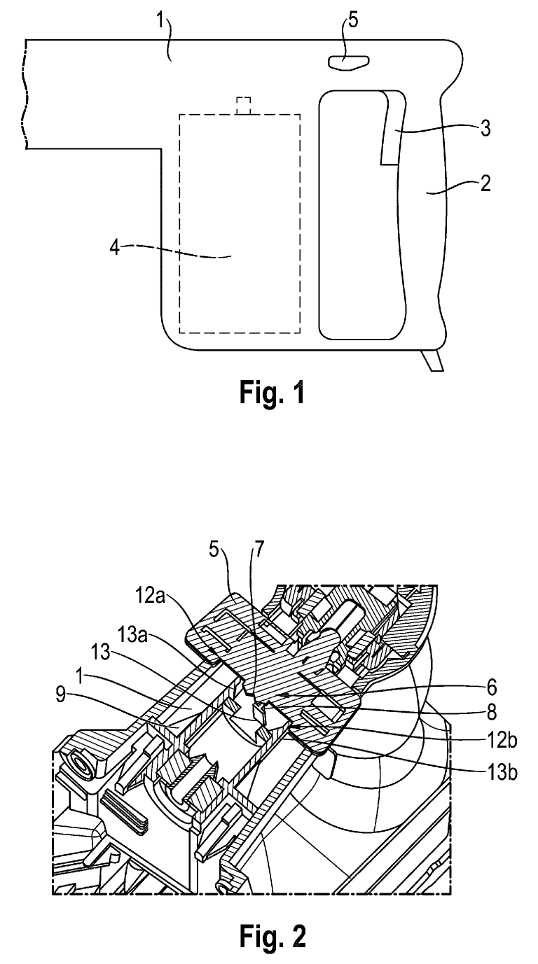

According to FIG. 2, a latching contour 7 containing a plurality of switching positions is integrally formed on a central edge region 6 of the direction switch 5. The latching contour 7 of the direction switch 5 interacts with spring means formed on the machine housing 1, which means consist, in this embodiment, of an injection-molded spring tongue 8 which extends outward.

In addition, the direction switch 5 has an edge shoulder 12a, 12b on either side adjacent to the latching contour 7, which interacts with a stop structure 13 projecting from the center of the machine housing to form end stops 13a, 13b on both sides. The edge shoulders 12a and 12b thus limit the press-in depth of the direction switch 5. A stop 13a on the stop structure 13 is provided for cooperation with the edge shoulder 12a and a stop 13b on the stop structure 13 is provided for cooperation with the edge shoulder 12b. In this embodiment, the stop structure 13 also serves to fasten a bearing block 9.

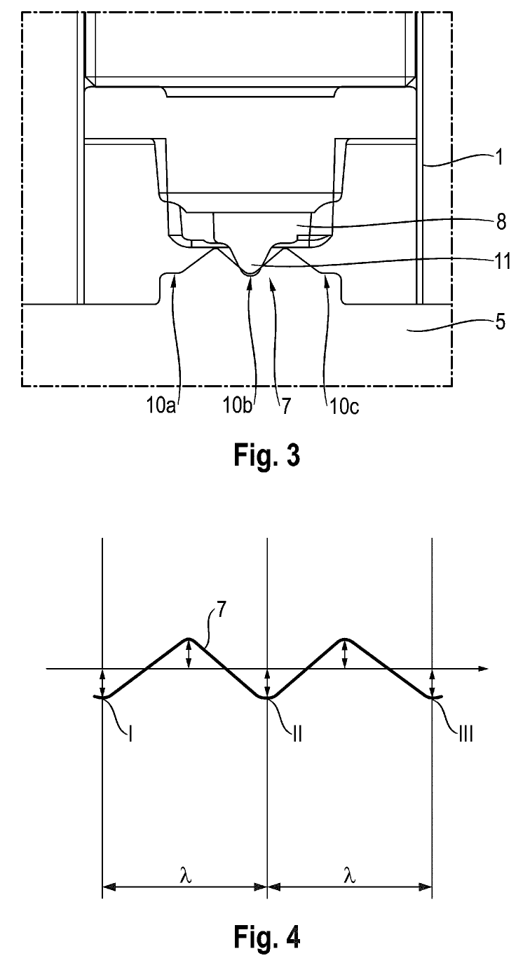

According to FIG. 3, the latching contour 7 of the direction switch 5 is wave-shaped, with its wave trough regions 10a to 10c each forming a switching position. A rounded cam section 11 arranged at the distal end of the spring tongue 8 comes to rest herein.

According to FIG. 4, the latching contour 7 extending along two wavelengths λ ensures a total of three switching positions. Each wavelength λ corresponds to the distance between the switching positions. The first switching position I on the left corresponds to the clockwise direction of rotation. The middle switching position II corresponds to a neutral position in which the rotary drive is inoperative, and the third switching position III corresponds to a counterclockwise direction of rotation.

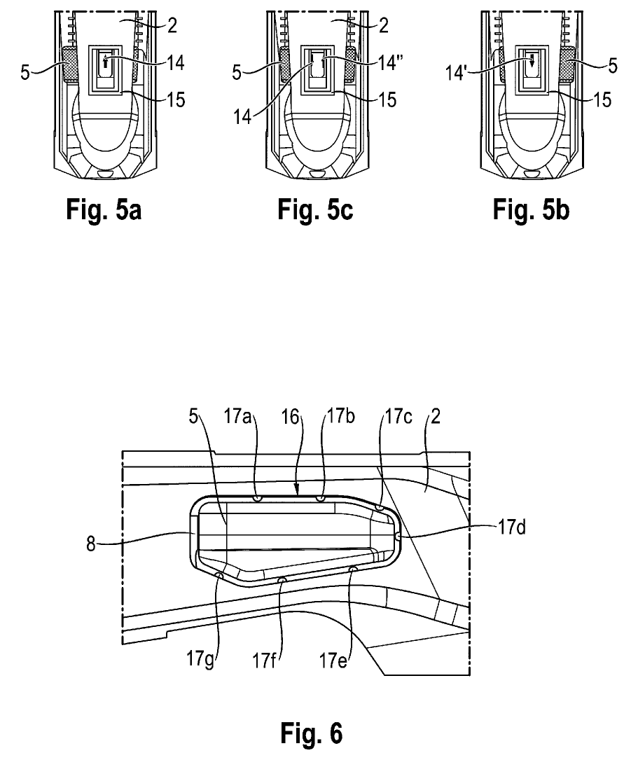

As can be seen from FIG. 5a, the direction switch 5 has an arrow marking on the top to indicate the direction, which marking is visible through a window opening 15 in the handle section 2 of the machine housing (not shown in more detail here). The arrow marking shows a forward-pointing arrow 14 to indicate a clockwise direction of rotation.

According to FIG. 5b, a rearward-pointing arrow 14' is provided to indicate a counterclockwise direction of rotation, which appears in the other switching position of the direction switch 5.

In addition, according to FIG. 5c, a middle neutral position of the direction switch 5 is indicated by the region between the two arrows 14 and 14' being visible in the window opening 15. In order to correspondingly visually indicate this, the two arrows 14 and 14' are only partially visible.

According to FIG. 6, the direction switch 5 designed as a slide switch is arranged within a continuous housing receptacle 16 in the handle section 2 of the machine housing (not shown in more detail here) and is guided in the operating direction via guide ribs 17, 17b, 17c, 17e, 17f and 17g. The guide rib 17d serves to apply pretension to the spring tongue 8 acting opposite on the direction switch 5.

The invention is not limited to the preferred exemplary embodiment described above. On the contrary, modifications thereof are also conceivable, which are encompassed by the scope of protection of the following claims. For example, it is also possible to design the spring means as separate spring elements. In addition, the latching contour can also be designed having a different geometry, for example corresponding to a triangular curve.

### LIST OF REFERENCE SIGNS

1 Machine housing

2 Handle section

3 Main switch

4 Rotary drive

5 Direction switch

6 Edge region

7 Latching contour

8 Spring tongue

9 Bearing block

10 Wave trough region

11 Cam section

12 Edge shoulder

13 Stop structure

14 Arrow

15 Window opening

16 Housing receptacle

17 Guide rib

What is claimed is:

1. A power tool comprising;
a bidirectional rotary drive;
a machine housing having a handle section;
a main switch arranged within reach of the handle section for switching the rotary drive on and off; and
a direction switch for selecting a direction of rotation of the rotary drive, the direction switch designed as a slide switch operatable on both sides of the machine housing depending on the direction of rotation to be selected; and
a latching contour containing at least two switching positions being integrally formed on a central edge region of the direction switch, the latching contour interacting with a spring arranged on the machine housing and engaging with the contour without any play.

2. The power tool as recited in claim 1 wherein the spring arranged on the machine housing is a spring tongue integrally formed in the handle section of the machine housing, the tongue extending outward and having a rounded cam section at a distal end and resiliently resting on the latching contour.

3. The power tool as recited in claim 2 wherein the spring tongue is pretensioned by a guide rib arranged on an opposite side of the direction switch and integrally formed on the machine housing, further guide ribs surrounding the direction switch so as to be parallel to and spaced apart from one another ensure the longitudinal guidance of the direction switch within a continuous housing receptacle.

4. The power tool as recited in claim 1 wherein the latching contour is wave-shaped and has wave trough regions each forming a switching position.

5. The power tool as recited in claim 1 wherein the direction switch has at least one arrow marking on the top for indicating the direction and visible through a window opening in the handle section of the machine housing.

6. The power tool as recited in claim 5 wherein the arrow marking comprises a forward-pointing arrow for indicating a clockwise direction of rotation and a rearward-pointing arrow arranged in parallel therewith and at a spacing therefrom for indicating a counterclockwise direction of rotation.

7. The power tool as recited in claim 5 wherein a region between two of the arrows in the window opening is visible in order to indicate a middle neutral position of the direction switch.

8. The power tool as recited in claim 1 wherein the direction switch has an edge shoulder adjacent to the latching contour on both sides, the edge shoulders interacting with a stop structure projecting from a center of the machine housing side to form end stops on both sides.

9. The power tool as recited in claim 1 wherein the direction switch is arranged on the outside of the handle section in such a way that to be operatable in one direction using at least the thumb of one hand when the handle section is grasped.

10. The power tool as recited in claim 1 wherein the main switch arranged adjacently to the direction switch is designed as a two-finger switch and is arranged on the inside of the handle section in such a way to be operable using at least the index or middle finger of one hand when the handle section is grasped.
